(19) United States
(12) Patent Application Publication
(10) Pub. No.: US 2006/0010482 A1
(43) Pub. Date: Jan. 12, 2006

(54) Audio/video transmission device

(75) Inventor: Chao-Cheng Li, Taipei (TW)

Correspondence Address: MADSON & METCALF;GATEWAY TOWER WEST, SUITE 900, 15 WEST SOUTH TEMPLE, SALT LAKE CITY, UT, 84101, US

(73) Assignee: Apacer Technology, Inc.

(21) Appl. No.: 11/178,634

(22) Filed: Jul. 11, 2005

(30) Foreign Application Priority Data
Jul. 9, 2004 (TW) 093120681

(51) Int. Cl. H04N 7/16

(52) U.S. Cl. 725/153

(57) ABSTRACT

An audio/video transmission includes an encoder, a storage medium, a decoder and a wireless transmission controller. The encoder is used for coding the audio/video signal into an audio/video file. The storage medium is electrically connected to the encoder for storing the audio/video file. The decoder is electrically connected to the storage medium for decoding the audio/video file into the audio/video signal. The wireless transmission controller is electrically connected to the decoder, and in wireless communication with an external wireless interface so as to perform data exchange between the wireless transmission controller and the external wireless interface.

### FIELD OF THE INVENTION

The present invention relates to a transmission device, and more particularly to an audio/video transmission device.

### BACKGROUND OF THE INVENTION

With digitalized trend, many consumable electronic products are developed to integrate high-quality digital audio/video contents into diverse apparatuses. In this generation, a multimedia device is one of the well-established consumable electronic products. With the user's requirement, favorite songs are stored in the memory unit of the multimedia device. Alternatively, voice data are converted into audio/video files, which are stored into the memory unit.

In order to achieve resource sharing functions, a transmission wire is required to interconnect the multimedia device with a personal computer such that the audio/video files or songs included in the multimedia device can be transmitted to the personal computer and stored therein. On the other hand, the audio/video files or songs stored in the personal computer can be downloaded into another multimedia device via the transmission wire. In other words, data exchange between one multimedia and another multimedia should be implemented via an intermediary personal computer. Since data fail to be directly transmitted from one multimedia to another multimedia, this approach is not user-friendly.

In views of the above-described disadvantages, the applicant keeps on carving unflaggingly to develop an audio/video transmission device according to the present invention through wholehearted experience and research.

### SUMMARY OF THE INVENTION

An object of the present invention is to provide an audio/video transmission device for implementing data exchange and resource sharing without using the intermediary personal computer.

In accordance with a first aspect of the present invention, there is provided an audio/video transmission device for receiving an audio/video signal. The audio/video transmission comprises an encoder, a storage medium, a decoder and a wireless transmission controller. The encoder is used for coding the audio/video signal into an audio/video file. The storage medium is electrically connected to the encoder for storing the audio/video file. The decoder is electrically connected to the storage medium for decoding the audio/video file into the audio/video signal. The wireless transmission controller is electrically connected to the decoder, and in wireless communication with an external wireless interface so as to perform data exchange between the wireless transmission controller and the external wireless interface.

In an embodiment, the encoder is a MPEG4 encoder for converting the audio/video signal into the audio/video file in a MPEG4 format. The decoder is a MPEG4 decoder for decoding the audio/video file in the MPEG4 format into the audio/video signal.

In an embodiment, the encoder is a MP3 encoder for converting the audio/video signal into the audio/video file in a MP3 format. The decoder is a MP3 decoder for decoding the audio/video file in the MP3 format into the audio/video signal.

Preferably, the storage medium is selected from a group consisting of a flash memory, a compact disc-rewritable (CD-RW) and a digital versatile disk-rewritable (DVD-RW).

In an embodiment, the wireless transmission controller is operated according to an IEEE 802.16 protocol, and the external wireless interface is an IEEE 802.16 wireless interface.

In an embodiment, the wireless transmission controller is operated according to an ultra-wideband (UWB) protocol, and the external wireless interface is a UWB wireless interface.

In an embodiment, the audio/video transmission device further comprises a USB OTG (On-The-Go) controller electrically connected to the storage medium and in communication with an external USB interface so as to exchange the audio/video file between the USB OTG controller and the external USB interface.

In accordance with a second aspect of the present invention, there is provided an audio/video transmission device for receiving an audio/video signal. The audio/video transmission device comprises a signal converter, a storage medium and a USB OTG (On-The-Go) controller. The signal converter is used for converting the audio/video signal into an audio/video file and decoding the audio/video file into the audio/video signal. The storage medium is electrically connected to the signal converter for storing the audio/video file. The USB OTG (On-The-Go) controller electrically connected to the storage medium and in communication with an external USB interface so as to exchange the audio/video file between the USB OTG controller and the external USB interface.

In an embodiment, the signal converter is an encoder-decoder.

In an embodiment, the signal converter is a MPEG4 encoder-decoder for converting the audio/video signal into an audio/video file in a MPEG4 format and decoding the audio/video file into the audio/video signal.

In an embodiment, the signal converter is a MP3 encoder-decoder for converting the audio/video signal into an audio/video file in a MP3 format and decoding the audio/video file into the audio/video signal.

In accordance with a third aspect of the present invention, there is provided an audio/video transmission device for receiving an audio/video signal. The audio/video transmission device comprises a coder, a storage medium, a decoder, a first wireless transmission controller, a second wireless transmission controller and a USB OTG (On-The-Go) controller. The encoder is used for encoding the audio/video signal into an audio/video file. The storage medium is electrically connected to the encoder for storing the audio/video file. The decoder is electrically connected to the storage medium for decoding the audio/video file into the audio/video signal. The first wireless transmission controller is electrically connected to the decoder, operated according to an IEEE 802.16 protocol and in wireless communication with an external IEEE 802.16 wireless interface so as to perform data exchange between the first wireless transmission controller and the external IEEE 802.16 wireless interface. The second wireless transmission controller is electrically connected to the decoder, operated according to an UWB protocol and in wireless communication with an external UWB wireless interface so as to perform data exchange between the second wireless transmission controller and the external UWB wireless interface. The USB OTG (On-The-Go) controller is electrically connected to the storage medium and in communication with an external USB interface so as to exchange the audio/video file between the USB OTG controller and the external USB interface.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit configuration of an audio/video transmission device according to a first preferred embodiment of the present invention;

FIG. 2 is a schematic circuit configuration of an audio/video transmission device according to a second preferred embodiment of the present invention;

FIG. 3 is a schematic circuit configuration of an audio/video transmission device according to a third preferred embodiment of the present invention; and

FIG. 4 is a schematic circuit configuration of an audio/video transmission device according to a fourth preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

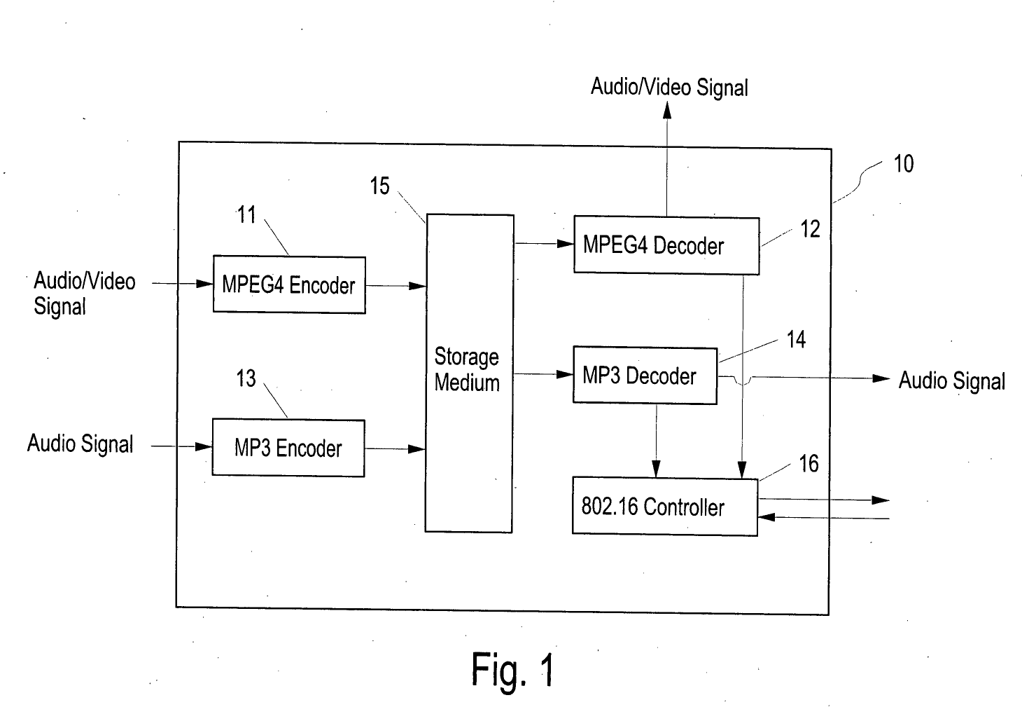

Referring to FIG. 1, a schematic circuit configuration of an audio/video transmission device according to a first preferred embodiment of the present invention is shown. The audio/video transmission device 10 comprises a MPEG4 encoder 11, a MPEG4 decoder 12, a MP3 encoder 13, a MP3 decoder 14, a storage medium 15 and a wireless transmission controller 16.

The MPEG4 encoder 11 is electrically connected to the storage medium 15 for receiving audio/video signals in an analog or digital form. The audio/video signals are then converted to audio/video files in a MPEG4 format. By the MPEG4 decoder 12, the audio/video files stored in the storage medium 15 will be decoded, and the decoded audio/video signals are outputted as required.

The MP3 encoder 13 is electrically connected to the storage medium 15 for receiving audio signals in an analog or digital form such as music songs. The audio signals are then converted to audio files in a MP3 format. By the MP3 decoder 14, the audio files stored in the storage medium 15 will be decoded, and the decoded audio signals are outputted as required.

The wireless transmission controller 16 is electrically connected to the MPEG4 decoder 12 and operated according to the IEEE 802.16 protocol. This wireless transmission controller 16 can be wirelessly communicated with an external IEEE 802.16 wireless interface (not shown) so as to perform data exchange between this wireless transmission controller 16 and the external IEEE 802.16 wireless interface.

The IEEE 802.16 wireless interface is a specialized wireless interface for transmitting audio or video signals but fails to directly access the general data files. Prior to data exchange between this wireless transmission controller 16 and the external IEEE 802.16 wireless interface, the MPEG4 audio/video files and the MP3 files stored in the storage medium 15 should be decoded via the MPEG4 decoder 12 and MP3 decoder 14, respectively.

The storage medium 15 can store the MPEG4 audio/video files and the MP3 files. In addition, the backup audio or video files stored in the external data processing apparatus can be transmitted from the external IEEE 802.16 wireless interface to the audio/video transmission device 10 of the present invention and stored in the storage medium 15.

Since the audio/video transmission device 10 of the present invention is communicated with the external IEEE 802.16 wireless interface to perform data exchange between this wireless transmission controller 16 and the external IEEE 802.16 wireless interface, no additional intermediary personal computer is required, and thus the audio/video transmission device 10 of the present invention is more user-friendly than that of prior art.

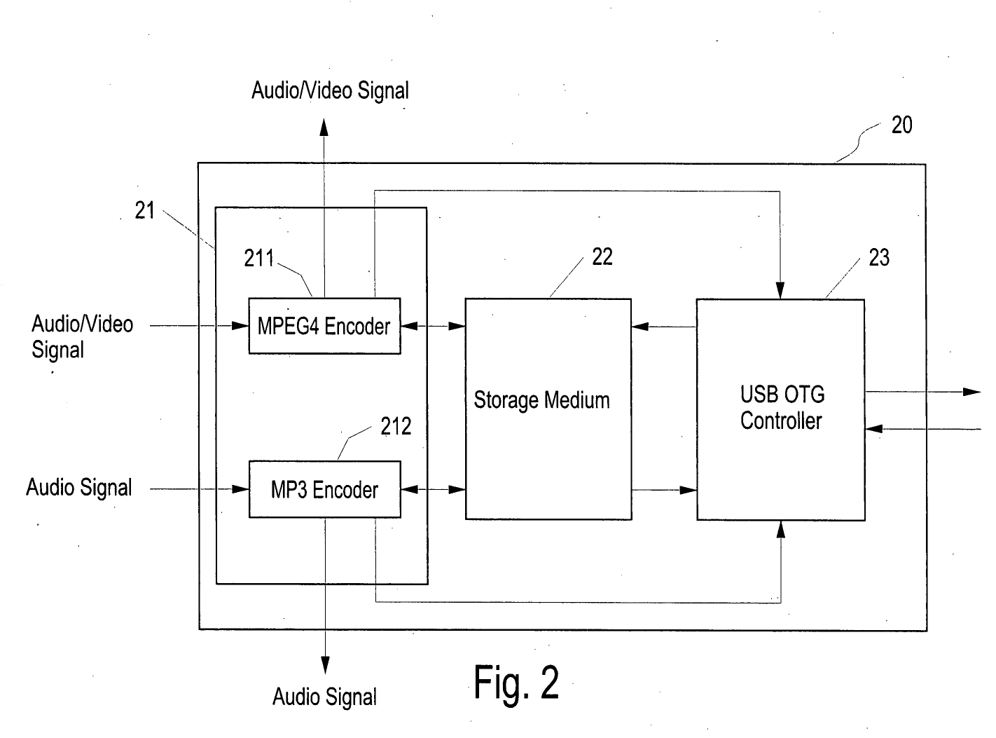

Referring to FIG. 2, a schematic circuit configuration of an audio/video transmission device according to a second preferred embodiment of the present invention is shown. The audio/video transmission device 20 comprises a signal converter 21, a storage medium 22 and a USB OTG (On-The-Go) controller 23.

The signal converter 21 is electrically connected to the storage medium 22, and comprises a MPEG4 encoder-decoder (CODEC) 211 and a MP3 encoder-decoder 212. Via the MPEG4 encoder-decoder 211, the inputted audio/video signals in an analog or digital form are converted to audio/video files in a MPEG4 format and then stored in the storage medium 22. In a case that the audio/video files are decoded via the MPEG4 encoder-decoder 211, the audio/video signals will be outputted to be played. Via the MP3 encoder-decoder 212, the audio signals in an analog or digital form such as music songs are converted to audio files in a MP3 format and then stored in the storage medium 22. In a case that the audio files are decoded via the MP3 encoder-decoder 212, the audio signals will be outputted to be played.

The USB OTG controller 23 is electrically connected to the MPEG4 encoder-decoder 211, the MP3 encoder-decoder 212 and the storage medium 22. The USB OTG controller 23 is implemented by a USB OTG interface, which is an extended USB2.0 specification. When a transmission wire (not shown) is coupled to an external data processing apparatus having a USB interface, the audio/video transmission device 20 of the present invention can be communicated with the external data processing apparatus to perform data exchange.

Since the USB OTG interface may directly access the general data files, the MPEG4 audio/video files or MP3 audio files stored in the storage medium 22 can be transmitted to the external data processing apparatus having the USB interface.

The storage medium 22 can store the MPEG4 audio/video files and the MP3 files. In addition, the backup audio or video files stored in external data processing apparatus can be transmitted from the USB interface thereof to the audio/video transmission device 20 of the present invention and stored in the storage medium 22.

Since the audio/video transmission device 20 of the present invention is communicated with the external USB interface to perform data exchange between the USB OTG controller 23 and the external USB interface, no additional intermediary personal computer is required, and thus the audio/video transmission device 20 of the present invention is more user-friendly than that of prior art.

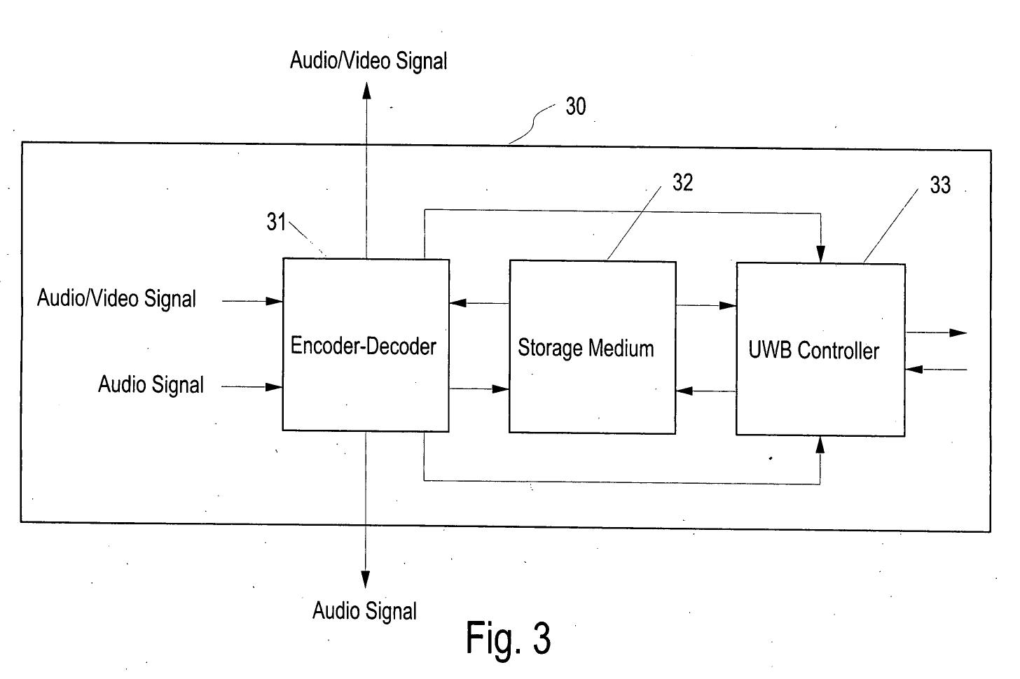

Referring to FIG. 3, a schematic circuit configuration of an audio/video transmission device according to a third preferred embodiment of the present invention is shown. The audio/video transmission device 30 comprises a signal converter 31, a storage medium 32 and an ultra-wideband (UWB) controller 33.

The signal converter 31 is an encoder-decoder electrically connected to the storage medium 32 and the UWB controller 33, and has both coding and decoding functions. Via the signal converter 31, the inputted audio/video signals or the audio signals in an analog or digital form are converted to audio/video files in a MPEG4 or MP3 format and stored in the storage medium 32. In a case that the MPEG4 audio/video files or the MP3 audio files are decoded via the signal converter 31, the MPEG4 audio/video signals or the MP3 audio signals will be outputted to play.

The UWB controller 33 is implemented by a UWB wireless interface so as to perform wireless date exchange between the UWB controller 33 and an external UWB wireless interface. Alternatively, via the UWB controller 33, the decoded MPEG4 audio/video signals or MP3 audio signals can be directly transmitted to the external data processing apparatus having the external UWB wireless interface so as to be outputted to play.

The storage medium 32 can store the MPEG4 audio/video files and the MP3 files. In addition, the backup audio or video files stored in the external data processing apparatus can be transmitted from the UWB interface thereof to the audio/video transmission device 30 of the present invention and stored in the storage medium 32.

Since the audio/video transmission device 30 of the present invention is communicated with the external UWB interface to perform data exchange between the UWB controller 33 and the external UWB interface, no additional intermediary personal computer is required, and thus the audio/video transmission device 30 of the present invention is more user-friendly than that of prior art.

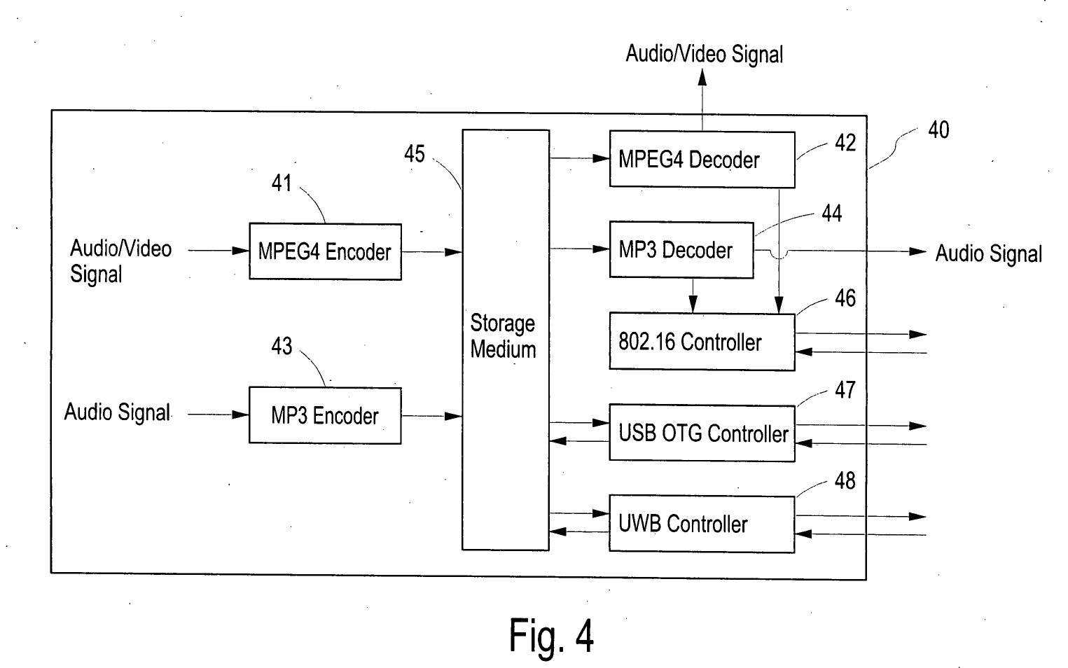

Referring to FIG. 4, a schematic circuit configuration of an audio/video transmission device according to a fourth preferred embodiment of the present invention is shown. The audio/video transmission device 40 comprises a MPEG4 encoder 41, a MPEG4 decoder 42, a MP3 encoder 43, a MP3 decoder 44, a storage medium 45, a wireless transmission controller (IEEE 802.16) 46, a USB OTG (On-The-Go) controller 47 and an ultra-wideband (UWB) controller 48. The operation principles of the MPEG4 encoder 41, the MPEG4 decoder 42, the MP3 encoder 43, the MP3 decoder 44, the storage medium 45, the IEEE 802.16 controller 46, the USB OTG controller 47 and the UWB controller 48 are similar to those described above, and are not intended to be described redundantly herein.

Since the IEEE 802.16 interface, the USB OTG interface and the UWB interface are integrated into the audio/video transmission device 40 of this embodiment, the audio/video transmission device 40 of the present invention can be communicated with any external data processing apparatus having the IEEE 802.16 interface, USB OTG interface or UWB interface.

It is noted that, however, those skilled in the art will readily observe that numerous modifications and alterations of the transmission may be made while retaining the teachings of the invention. Accordingly, the above disclosure should be limited only by the bounds of the following claims.

In the above embodiments, each of the storage medium 15, 22, 32 and 45 can be a flash memory, a compact disc-rewritable (CD-RW) or a digital versatile disk-rewritable (DVD-RW).

From the above description, the audio/video transmission device of the present invention is capable of implementing data exchange and resource sharing without using the intermediary personal computer. The encoder-decoder used in the above embodiments has functions of encoding and decoding the MPEG4 audio/video files or MP3 audio files. The backup audio or video files stored in the storage medium can be transmitted to the external data processing apparatus. In addition, the backup audio or video files stored in the external data processing apparatus can be transmitted from the external interface to the audio/video transmission device of the present invention and stored in the storage medium of the audio/video transmission device. Moreover, in addition to transmitting data, the audio/video transmission device of the present invention can be used to play the audio or video files, and thus the audio/video transmission device of the present invention is more flexible.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An audio/video transmission device for receiving an audio/video signal, comprising:
an encoder for coding said audio/video signal into an audio/video file;
a storage medium electrically connected to said encoder for storing said audio/video file;
a decoder electrically connected to said storage medium for decoding said audio/video file into said audio/video signal; and
a wireless transmission controller electrically connected to said decoder, and in wireless communication with an external wireless interface so as to perform data exchange between said wireless transmission controller and said external wireless interface.

2. The audio/video transmission device according to claim 1 wherein said encoder is a MPEG4 encoder for converting said audio/video signal into said audio/video file in a MPEG4 format.

3. The audio/video transmission device according to claim 2 wherein said decoder is a MPEG4 decoder for decoding said audio/video file in said MPEG4 format into said audio/video signal.

4. The audio/video transmission device according to claim 1 wherein said encoder is a MP3 encoder for converting said audio/video signal into said audio/video file in a MP3 format.

5. The audio/video transmission device according to claim 4 wherein said decoder is a MP3 decoder for decoding said audio/video file in said MP3 format into said audio/video signal.

6. The audio/video transmission device according to claim 1 wherein said storage medium is selected from a group consisting of a flash memory, a compact disc-rewritable (CD-RW) and a digital versatile disk-rewritable (DVD-RW).

7. The audio/video transmission device according to claim 1 wherein said wireless transmission controller is operated according to an IEEE 802.16 protocol, and said external wireless interface is an IEEE 802.16 wireless interface.

8. The audio/video transmission device according to claim 1 wherein said wireless transmission controller is operated according to an ultra-wideband (UWB) protocol, and said external wireless interface is a UWB wireless interface.

9. The audio/video transmission device according to claim 1 further comprising a USB OTG (On-The-Go) controller electrically connected to said storage medium and in communication with an external USB interface so as to exchange said audio/video file between said USB OTG controller and said external USB interface.

10. An audio/video transmission device for receiving an audio/video signal, comprising:
a signal converter for converting said audio/video signal into an audio/video file and decoding said audio/video file into said audio/video signal;
a storage medium electrically connected to said signal converter for storing said audio/video file; and
a USB OTG (On-The-Go) controller electrically connected to said storage medium and in communication with an external USB interface so as to exchange said audio/video file between said USB OTG controller and said external USB interface.

11. The audio/video transmission device according to claim 10 wherein said signal converter is an encoder-decoder.

12. The audio/video transmission device according to claim 11 wherein said signal converter is a MPEG4 encoder-decoder for converting said audio/video signal into an audio/video file in a MPEG4 format and decoding said audio/video file into said audio/video signal.

13. The audio/video transmission device according to claim 11 wherein said signal converter is a MP3 encoder-decoder for converting said audio/video signal into an audio/video file in a MP3 format and decoding said audio/video file into said audio/video signal.

14. The audio/video transmission device according to claim 10 further comprising a wireless transmission controller electrically connected to said decoder, and in wireless communication with an external wireless interface so as to perform data exchange between said wireless transmission controller and said external wireless interface.

15. The audio/video transmission device according to claim 14 wherein said wireless transmission controller is operated according to an IEEE 802.16 protocol, and said external wireless interface is an IEEE 802.16 wireless interface.

16. The audio/video transmission device according to claim 14 wherein said wireless transmission controller is operated according to an ultra-wideband (UWB) protocol, and said external wireless interface is a UWB wireless interface.

17. The audio/video transmission device according to claim 10 wherein said storage medium is selected from a group consisting of a flash memory, a compact disc-rewritable (CD-RW) and a digital versatile disk-rewritable (DVD-RW).

18. An audio/video transmission device for receiving an audio/video signal, comprising:
an encoder for coding said audio/video signal into an audio/video file;
a storage medium electrically connected to said encoder for storing said audio/video file;
a decoder electrically connected to said storage medium for decoding said audio/video file into said audio/video signal;
a first wireless transmission controller electrically connected to said decoder, operated according to an IEEE 802.16 protocol and in wireless communication with an external IEEE 802.16 wireless interface so as to perform data exchange between said first wireless transmission controller and said external IEEE 802.16 wireless interface;
a second wireless transmission controller electrically connected to said decoder, operated according to an UWB protocol and in wireless communication with an external UWB wireless interface so as to perform data exchange between said second wireless transmission controller and said external UWB wireless interface; and
a USB OTG (On-The-Go) controller electrically connected to said storage medium and in communication with an external USB interface so as to exchange said audio/video file between said USB OTG controller and said external USB interface.

19. The audio/video transmission device according to claim 18 wherein said storage medium is selected from a group consisting of a flash memory, a compact disc-rewritable (CD-RW) and a digital versatile disk-rewritable (DVD-RW).

20. The audio/video transmission device according to claim 18 wherein said encoder is a MPEG4 or MP3 encoder, and said decoder is a MPEG4 or MP3 decoder.
